(19) United States
(12) Patent Application Publication
(10) Pub. No.: US 2013/0071631 A1
(43) Pub. Date: Mar. 21, 2013

(54) Method For Forming A Metal-Plastic Composite And The Metal-Plastic Composite Made Thereby

(71) Applicant: Kuang-Cheng Chao, New Taipei City (TW)

(72) Inventor: Kuang-Cheng Chao, New Taipei City (TW)

(21) Appl. No.: 13/238,827

(22) Filed: Sep. 21, 2011

(51) Int. Cl. B32B 3/00; B32B 15/04; B29C 65/48

(52) U.S. Cl. 428/195.1; 156/245; 428/457

(57) ABSTRACT

Disclosed is a method for forming a metal-plastic composite which includes the steps of: a) activating a first surface of a metal substrate; b) applying an adhesive material on the first surface that has been activated to form an adhesive layer on the first surface; and c) placing the metal substrate together with the adhesive layer in a mold and injection molding a plastic material over the adhesive layer. A metal-plastic composite made by the method is also disclosed.

### BACKGROUND OF THE INVENTION

1. Field of the Invention

The invention relates to a method for forming a metal-plastic composite, and more particularly to a method for forming a metal-plastic composite by injection molding.

The invention also relates to a metal-plastic composite made by the method.

2. Description of the Related Art

In consumer electronics products (for example, mobile phones, electronic appliances, computers, or the like), parts of vehicles, or toys, an outer casing thereof is usually made of metal or plastic. When the outer casing is made by processing a metal material into a profiled structure by any of various machining technologies, there are some disadvantages such as high cost, insufficient fineness of an edge of the structure, etc. On the other hand, when the outer casing is made by molding a plastic material into a profiled structure, the mechanical strength of the outer casing made thereby may be insufficient. Therefore, a plastic material which is easy to be formed into a fine component is usually used together with a metal material which has a high mechanical strength to produce the components, such as an outer casing, for the consumer electronics products, the vehicles, or the like.

Conventionally, a plastic material is bonded to a metal material by using an adhesive, welding, supersonic bonding, or the like. When a plastic material is bonded to a metal material using an adhesive, the adhesive is applied on the plastic material or the metal material, followed by positioning the plastic material relative to the metal material, heating the adhesive, and compressing the plastic material against the metal material. The processing procedure using the adhesive is relatively complicated. Furthermore, it is difficult to control the precision of positioning the plastic material relative to the metal material. When a plastic material is bonded to a metal material by welding, part of the plastic material is molten so as to bond the plastic material to the metal material. Toxic gas is produced during the welding process. Furthermore, the welded part of the composite of the plastic material and the metal material is liable to break due to insufficient mechanical strength. The problems encountered in the welding process may be alleviated by a supersonic bonding process. However, when the supersonic bonding process is used, it is difficult to control the bonding thickness, and undesirable marks may be produced to mar the appearance of the composite of the plastic material and the metal material. The supersonic bonding process cannot be used for bonding a plastic material which is relatively soft or elastic and/or which has a relatively large size (for example, an area larger than 150 mm×100 mm) to a metal substrate.

In view of the aforesaid, it is desirable in the art to provide an improved method for bonding a plastic material to a metal material.

### SUMMARY OF THE INVENTION

An object of the present invention is to provide a method for forming a metal-plastic composite which is relatively simple and which provides sufficient bonding strength between the plastic and the metal.

Another object of the present invention is to provide a metal-plastic composite made by the method of the present invention.

In one aspect of this invention, a method for forming a metal-plastic composite includes the steps of:

a) activating a first surface of a metal substrate;

b) applying an adhesive material on the first surface that has been activated to form an adhesive layer on the first surface; and

c) placing the metal substrate together with the adhesive layer in a mold and injection molding a plastic material over the adhesive layer.

In another aspect of this invention, a metal-plastic composite produced by the method of the present invention includes a metal substrate having an activated first surface, an adhesive layer bonded to the activated first surface of the metal substrate, and a plastic layer bonded to the adhesive layer.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a flow chart of first and second preferred embodiments of a method for forming a metal-plastic composite according to the present invention;

FIGS. 2 to 6 are sectional views illustrating consecutive steps of the first preferred embodiment;

FIG. 7 is a fragmentary sectional view of a metal-plastic composite made according to the first preferred embodiment;

FIG. 8 is a fragmentary sectional view illustrating an injection molding step in the second preferred embodiment; and

FIG. 9 is a fragmentary sectional view of a metal-plastic composite made according to the second preferred embodiment.

### DETAILED DESCRIPTION OF THE PREFERRED EMBODIMENTS

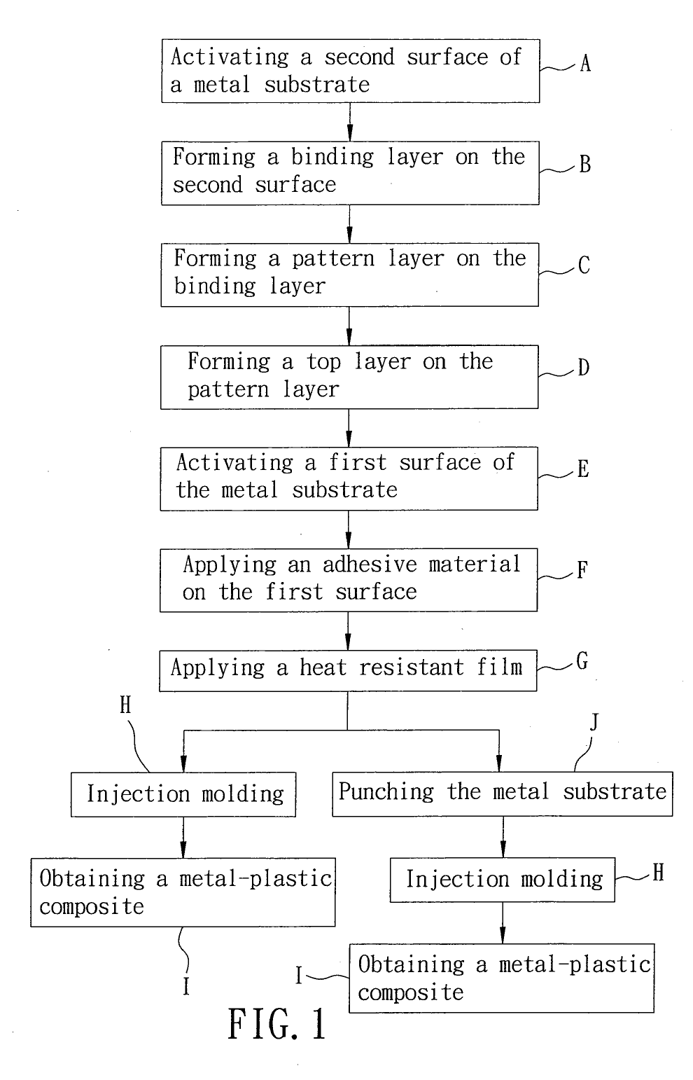

Referring to FIGS. 1 to 6, the first preferred embodiment of a method for forming a metal-plastic composite according to the present invention includes the steps of:

A) activating a second surface 11 of a metal substrate 1:

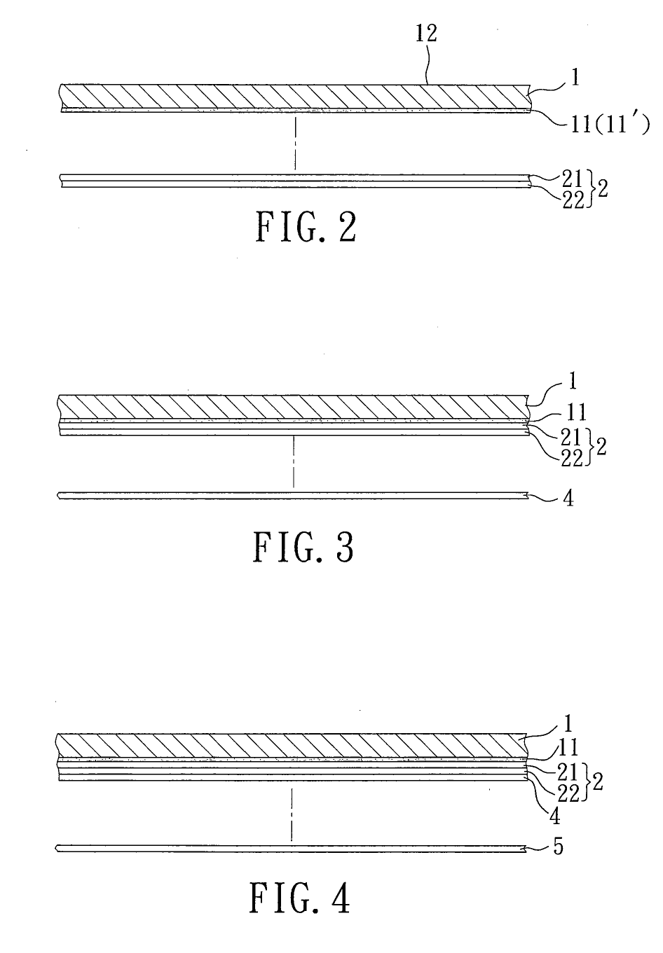

Specifically referring to FIG. 2, the metal substrate 1 can be made of any suitable metal material, such as an aluminum plate, and has a first surface 12 and a second surface 11 opposite to the first surface 12. The second surface 11 of the metal substrate 1 is activated by any suitable process well known in the art, such as an etching treatment, a plasma treatment, an ultraviolet treatment, a dipping treatment with a chemical agent, or a coating treatment with an activation agent. When the second surface 11 of the metal substrate 1 is activated by the etching treatment, the plasma treatment, or the dipping treatment with a chemical agent, the second surface 11 of the metal substrate 1 is formed with recesses having a depth of up to 20 μm. When the second surface 11 of the metal substrate 1 is activated by the coating treatment with an activation agent, the second surface 11 of the metal substrate 1 is formed with an activated layer (11′) having a thickness of up to 20 μm. When the second surface 11 of the metal substrate 1 is activated by the ultraviolet treatment, the second surface 11 of the metal substrate 1 is formed with free radicals for enhancing the subsequent bonding.

B) forming a binding layer 2 on the second surface 11:

Specifically referring to FIGS. 2 and 3, the binding layer 2 is formed on the second surface 11 that has been activated. In the preferred embodiment, the binding layer 2 is formed by applying a primer on the second surface 11 of the metal substrate 1 by spray coating to form a primer sub-layer 21 followed by applying a binder on the primer by spray coating to form a binder sub-layer 22 on the primer sub-layer 21. The primer sub-layer 21 has a thickness ranging from 1 μm to 100 μm, and the binder sub-layer 22 has a thickness ranging from 5 μm to 500 μm. Alternatively the primer and the binder can be mixed together to form a mixture, which is then applied on the second surface 11 that has been activated to form the binding layer 2 on the second surface 11. In addition to the spray coating, applying of the primer, the binder, or the mixture thereof can be conducted via digital jet printing, screen printing, dipping, or the like.

The primer can be made of urea-formaldehyde resin, acrylate resin, epoxy resin, UV curing resin, polyurethane, melamine-formaldehyde resin, or combinations thereof. The binder can be made of polyvinyl acetate, acrylate resin, epoxy resin, UV curing resin, polyurethane, melamine-formaldehyde resin, polyethylene terephthalate, unsaturated polyester, alkyd, or combinations thereof.

C) forming a pattern layer 4 on the binding layer 2:

Specifically referring to FIGS. 3 and 4, the pattern layer 4 is formed on the binding layer 2 by digital jet printing, screen printing, sublimation transfer-printing, or the like. The pattern layer 4 can be formed of solvent ink, UV ink, pigment ink, or the like, and has a thickness ranging from 0 μm to 300 μm. When the ink permeates into the binding layer 2, the pattern layer 4 has a thickness of 0 μm.

D) forming a top layer 5 on the pattern layer 4:

The top layer 5 can be formed on the pattern layer 4 by spray coating, digital jet printing, screen printing, or the like. The top layer 5 is made of a protective ink so as to form a transparent protective layer on the pattern layer 4. The thickness of the top layer 5 ranges from 1 μm to 50 μm. Optionally, decorative material, such as gold powder, silver powder, pearl powder, or the like can be added into the top layer 5 or the binding layer 2 so as to enhance the aesthetic effect.

E) activating the first surface 12 of the metal substrate 1:

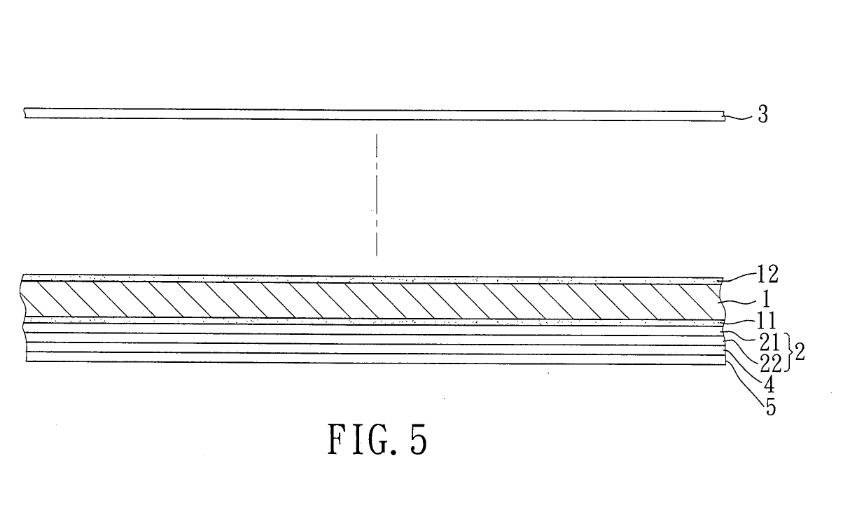

Specifically referring to FIG. 5, the first surface 12 of the metal substrate 1 is activated by the etching treatment, the plasma treatment, the ultraviolet treatment, the dipping treatment with a chemical agent, or the coating treatment with an activation agent.

F) applying an adhesive material on the first surface 12:

Specifically referring to FIG. 5, an adhesive material is applied on the first surface 12 that has been activated to form the adhesive layer 3 on the first surface 12. The adhesive layer 3 has a thickness ranging from 1 μm to 100 μm. Applying of the adhesive material can be conducted by spray coating, digital jet printing, screen printing, dipping, or the like. The adhesive material can be urea-formaldehyde resin, acrylate resin, hot melt adhesive, epoxy resin, amino resin, phenolic formaldehyde resin, UV curing resin, vinyl ester resin, polyvinyl acetate, polyurethane, melamine-formaldehyde resin, or combinations thereof.

G) applying a heat resistant film 51:

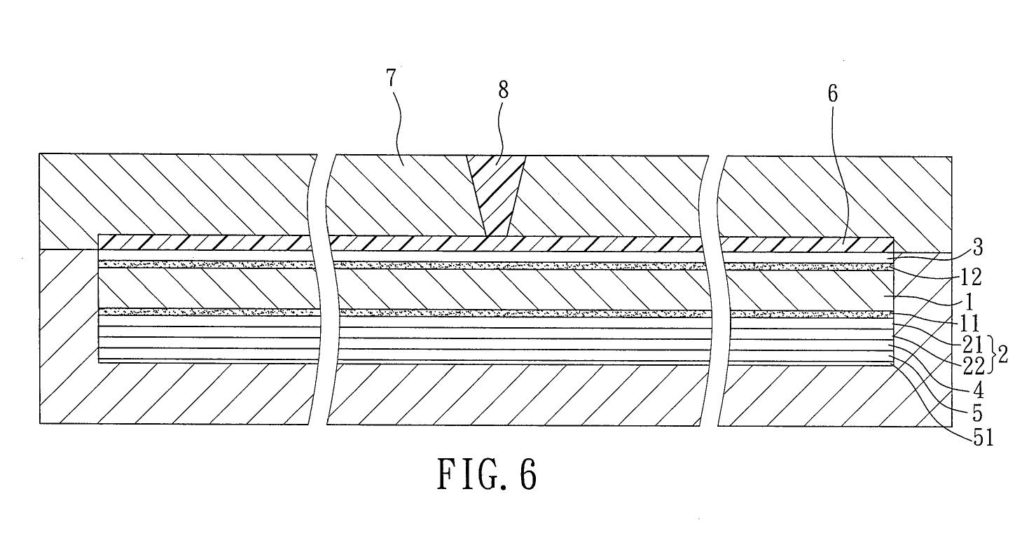

Specifically referring to FIG. 6, the heat resistant film 51 is applied on the top layer 5. The heat resistant film 51 is made of silicone rubber, polyethylene terephthalate, polyvinyl chloride, or the like.

H) injection molding:

Specifically referring to FIG. 6, the metal substrate 1 together with the adhesive layer 3, the binding layer 2, the pattern layer 4, the top layer 5, and the heat resistant film 51 is placed in a mold 7. A plastic layer 6 is integrated with and formed on the adhesive layer 3 by injection molding a plastic material 8 over the adhesive layer 3 at a molding temperature ranging from 60° C. to 300° C. for a period ranging from 1 second to 600 seconds. The shape and the thickness of the plastic layer 6 can be varied according to specific requirements for a metal-plastic composite to be produced. The plastic material 8 suitable for the present invention is polycarbonate, acrylonitrile-butadiene-styrene copolymer, polymethyl methacrylate, polybutyl terephthalate, polyethylene terephthalate, polyoxymethylene, polyphenylene sulfide, Nylon 66, or combinations thereof.

I) obtaining a metal-plastic composite:

A metal-plastic composite is obtained after removing from the mold 7 and stripping of the heat resistant film 51.

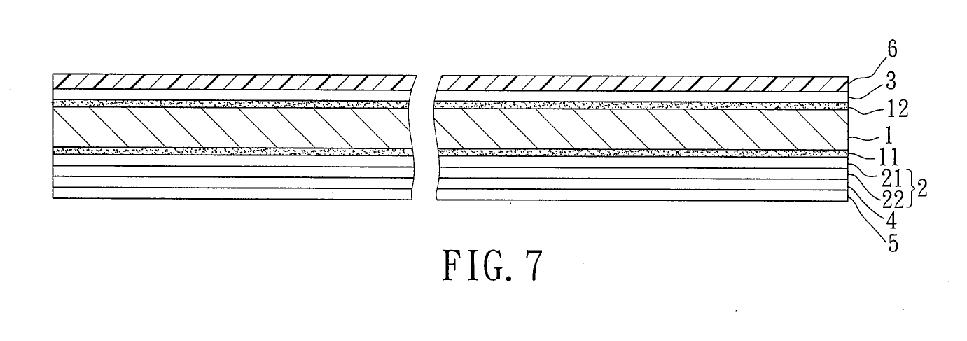

Referring to FIG. 7, the metal-plastic composite produced by the aforesaid method includes the metal substrate 1 having the activated first surface 12 and the activated second surface 11 opposite to the activated first surface 12, the adhesive layer 3 bonded to the activated first surface 12 of the metal substrate 1, the plastic layer 6 bonded to the adhesive layer 3, the binding layer 2 bound to the activated second surface 11 of the metal substrate 1, the pattern layer 4 formed on the binding layer 2, and the top layer 5 formed on the pattern layer 4. The binding layer 2 includes the primer sub-layer 21 formed on the activated second surface 11 of the metal substrate 1, and the binder sub-layer 22 formed on the primer sub-layer 21.

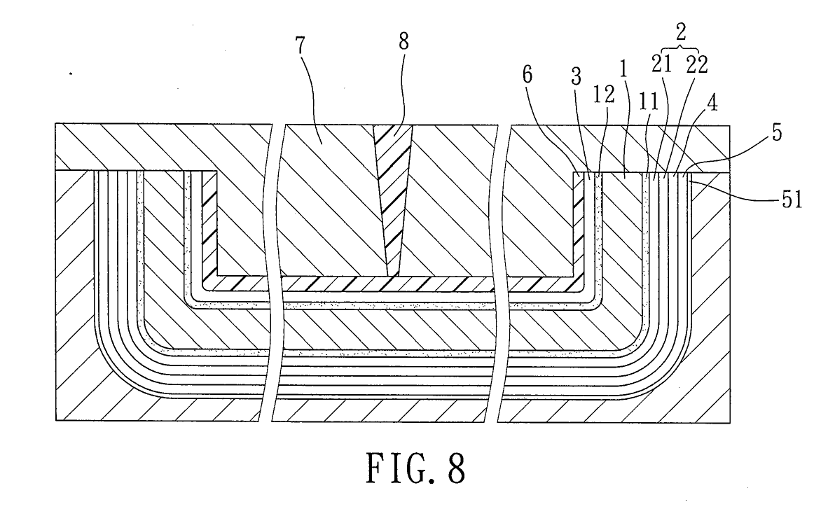

Referring to FIGS. 2 and 8, the second preferred embodiment of a method for forming a metal-plastic composite according to the present invention is similar to the first preferred embodiment except that step J) of punching the metal substrate 1 is performed after the aforesaid step G) of applying the heat resistant film 51 and prior to the aforesaid step H) of injection molding.

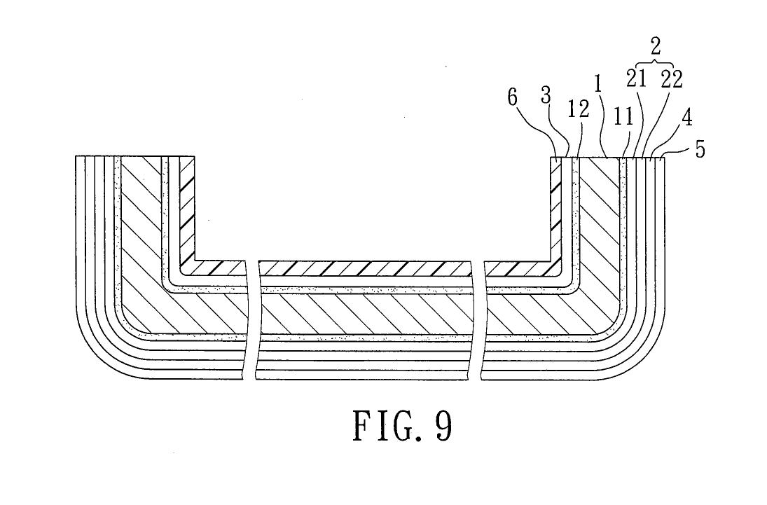

Referring to FIG. 9, a metal-plastic composite produced by the aforesaid second preferred embodiment of the method of the present invention is similar to the metal-plastic composite produced by the first preferred embodiment of the method of the present invention except that metal-plastic composite produced by the second preferred embodiment has a curved configuration.

In view of the aforesaid, the plastic layer 6 is integrally bonded to the metal substrate 1 via injection molding in the method of the present invention. The method for making a metal-plastic composite of the present invention is relatively simple and inexpensive as compared to the aforesaid conventional method. Furthermore, in the method of the present invention, the surfaces 11, 12 of metal substrate 1 are activated prior to bonding of the plastic layer 6 to the metal substrate 1 via the adhesive layer 3 using injection molding. Therefore, the bonding strength between the plastic layer 6 and the metal substrate 1 is enhanced.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for forming a metal-plastic composite, comprising the steps of:
a) activating a first surface of a metal substrate;
b) applying an adhesive material on the first surface that has been activated to form an adhesive layer on the first surface; and
c) placing the metal substrate together with the adhesive layer in a mold and injection molding a plastic material over the adhesive layer.

2. The method as claimed in claim 1, wherein the adhesive material is selected from the group consisting of urea-formaldehyde resin, acrylate resin, hot melt adhesive, epoxy resin, amino resin, phenolic formaldehyde resin, UV curing resin, vinyl ester resin, polyvinyl acetate, polyurethane, melamine-formaldehyde resin, and combinations thereof.

3. The method as claimed in claim 1, further comprising the steps of:
d) activating a second surface of the metal substrate opposite to the first surface;
e) forming a binding layer on the second surface that has been activated; and
f) forming a pattern layer on the binding layer.

4. The method as claimed in claim 3, further comprising a step of forming a top layer on the pattern layer.

5. The method as claimed in claim 4, wherein the top layer is formed by spray coating.

6. The method as claimed in claim 3, wherein the binding layer is formed by applying a primer on the second surface of the metal substrate and a binder on the primer.

7. The method as claimed in claim 6, wherein the primer is made of a material selected from the group consisting of urea-formaldehyde resin, acrylate resin, epoxy resin, UV curing resin, polyurethane, melamine-formaldehyde resin, and combinations thereof.

8. The method as claimed in claim 3, wherein the first and second surfaces of the metal substrate are activated by a process independently selected from the group consisting of:
i) an etching treatment;
ii) a plasma treatment;
iii) an ultraviolet treatment;
iv) a dipping treatment with a chemical agent; and
v) a coating treatment with an activation agent.

9. The method as claimed in claim 6, wherein the binder is made of a material selected from the group consisting of polyvinyl acetate, acrylate resin, epoxy resin, UV curing resin, polyurethane, melamine-formaldehyde resin, polyethylene terephthalate, unsaturated polyester, alkyd, and combinations thereof.

10. The method as claimed in claim 3, wherein the pattern layer is formed by a process selected from the group consisting digital jet printing and sublimation transfer-printing.

11. A metal-plastic composite produced by the method as claimed in claim 1, comprising:
a metal substrate having an activated first surface;
an adhesive layer bonded to said activated first surface of said metal substrate; and
a plastic layer bonded to said adhesive layer.

12. The metal-plastic composite as claimed in claim 11, wherein said metal substrate further has an activated second surface opposite to said activated first surface, said metal-plastic composite further comprising:
a binding layer bound to said activated second surface of said metal substrate; and
a pattern layer formed on said binding layer.

13. The metal-plastic composite as claimed in claim 12, further comprising a top layer formed on said pattern layer.

14. The metal-plastic composite as claimed in claim 12, wherein said binding layer includes a primer sub-layer formed on said activated second surface of said metal substrate, and a binder sub-layer formed on said primer sub-layer.
